(19) United States
(12) Patent Application Publication
(10) Pub. No.: US 2025/0389031 A1
(43) Pub. Date: Dec. 25, 2025

(54) SYSTEM AND METHODS OF WATER ELECTROLYSIS

(71) Applicant: Schlumberger Technology Corporation, Sugar Land, TX (US)

(72) Inventors: Wenlin Zhang, Menlo Park, CA (US); Alan Nelson, Houston, TX (US); Eric Lavrut, Clamart (FR); Rafael Fejervary, London (GB)

(21) Appl. No.: 19/248,515

(22) Filed: Jun. 25, 2025

Related U.S. Application Data
(60) Provisional application No. 63/663,725, filed on Jun. 25, 2024.

(51) Int. Cl. C25B 1/04; C25B 9/65; C25B 9/77; C25B 13/08

(52) U.S. Cl. CPC C25B 1/04; C25B 9/65; C25B 9/77; C25B 13/08

(57) ABSTRACT

The present disclosure generally provides systems and methods of water electrolysis. The systems include a first electrode set. The first electrode set includes a first bipolar plate electrically coupled to a power source. A first electrode is disposed adjacent to the first bipolar plate and in electrical contact with the first bipolar plate. The first actuator is electrically coupled to a second power source. The systems include a diaphragm. The first electrode is disposed adjacent to a first side of the diaphragm. The systems include a second electrode set. The second electrode set includes a second bipolar plate and a second electrode. The second electrode is disposed adjacent to a second side of the diaphragm. The second side is opposite the first side. The system include actuators embedded in the system to facilitate gas bubble expulsion to enhance electrolysis efficiency.

### CROSS-REFERENCE TO RELATED APPLICATIONS

This application claims priority to and the benefit of U.S. Provisional Patent Application No. 63/663,725, filed Jun. 25, 2024 which is incorporated herein by reference in its entirety.

### BACKGROUND

Electrolysis of water is utilized for the production of hydrogen (H₂) to be used as an alternative energy source and green hydrogen for hard-to-abate heavy industries such as chemical and steel industries. Electrolysis of water requires water as a feed material and converts, using an electrochemical cell, water into H₂ and diatomic oxygen (O₂) via a redox reaction by applying an external electrical power to the cell. Electrolysis of water is generally implemented by an electrolyzer system that includes one or more stacks of electrochemical cells. Electrolyzer cells make use of an electrochemical reaction in a cell that comprises an anode, cathode, catalyst, gas distribution field and electrolyte.

Conventional electrolyzer, such as liquid alkaline electrolyzers, suffer from gas bubbles forming on the electrodes and/or diaphragm, causing impedance for mass transfer of ionic species, and potentially blocking electrode reaction locations resulting in higher polarization. This can lead to reduced ionic conductivity and a higher percentage of gas bubbles in the liquid electrolyte, thereby increasing the likelihood for mixing oxygen and hydrogen gas formed by the electrolysis reaction and increasing safety and purity concerns.

Accordingly, improved methods of water electrolysis are needed.

### SUMMARY

The present disclosure generally provides systems and methods of water electrolysis. The systems include a first electrode set. The first electrode set includes a first bipolar plate electrically coupled to a power source. A first electrode is disposed adjacent to the first bipolar plate and in electrical contact with the first bipolar plate. The systems include a first actuator embedded in the first electrode. The first actuator is electrically coupled to a second power source. The systems include a diaphragm. The first electrode is disposed adjacent to a first side of the diaphragm. The systems include a second electrode set. The second electrode set includes a second bipolar plate and a second electrode. The second electrode is disposed adjacent to a second side of the diaphragm. The second side is opposite the first side.

The present disclosure also generally provides systems and methods of water electrolysis. The methods include generating a current between a first electrode set and a second electrode set separated by a diaphragm, and circulating water within one of the first electrode set or the second electrode set. The first electrode set includes a first bipolar plate electrically coupled to a power source, and a first electrode disposed adjacent to the first bipolar plate and to a first side of the diaphragm and in electrical contact with the first bipolar plate. The second electrode set includes a second bipolar plate and a second electrode. The second electrode is disposed adjacent to a second side of the diaphragm. The second side is opposite the first side, and in electrical contact with the second bipolar plate. The current, in the presence of water, produces an electrolysis reaction. An oscillation force is generated in the first electrode set using a first actuator. A first product of the electrolysis reaction is directed to a first channel fluidly coupled to the first electrode set using a diaphragm and the first oscillation force.

The following description and the appended figures set forth certain features for purposes of illustration.

### BRIEF DESCRIPTION OF DRAWINGS

So that the manner where the above recited features may be understood in detail, a more particular description, briefly summarized above, may be had by reference to example aspects, some of which are illustrated in the appended drawings.

FIG. 1 is a schematic view of an electrolyzer cell, according to embodiments of the present disclosure.

FIGS. 2A and 2B are schematic views of an electrolyzer cell having an embedded actuator, according to embodiments of the present disclosure.

FIGS. 3A and 3B are schematic views of a bipolar plate, according to embodiments of the present disclosure

FIG. 4 is a flow diagram of a method for electrolyzing water, according to embodiments of the present disclosure.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates to systems and methods of water electrolysis. The present disclosure includes a coating material disposed on a bipolar plate, e.g., a concave or planar portion of the bipolar plate, to prevent bubble adhesion to the bipolar plate walls. The coating material facilitates movement of the bubbles, e.g., gas bubbles of hydrogen and/or oxygen, towards the manifold to help improve overall energy efficiency and reduce over-potential. Additionally, the present disclosure includes an actuator embedded within the electrode and/or bipolar plate to generate a provide an oscillation force and turbulence in the electrolyte solution in the electrolyzer cell. The oscillation force and/or turbulence can forcefully detach bubbles e.g., gas bubbles of hydrogen and/or oxygen, from the electrode and/or diaphragm surface, towards a fluid channel to help improve overall energy efficiency and reduce over-potential. The present disclosure can provide a large-scale water electrolysis process capable of providing oscillation forces internal to the electrolyzer cell, thereby avoiding large-scale external ultrasonic frequencies that may pose health hazards and/or be costly, which could be less effective.

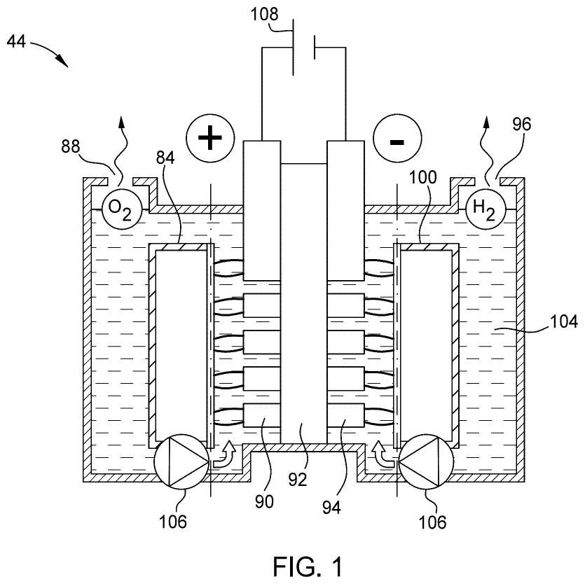

FIG. 1 shows a detailed view of the electrolyzer cell 44. In this view only one electrolyzer cell is shown, however, two or more electrolyzer cells may be coupled in series in order to produce more hydrogen. The electrolyzer cell 44 includes a first bipolar plate 84 that is adjacent to a first channel 88 and a first electrode 90. The first channel 88 may be a channel suitable to recover one or more reaction products of an electrolysis reaction, e.g., H₂ and/or O₂. For example, the first channel 88 may be suitable to recover a reaction product of O₂. A positive charge may be supplied to the first bipolar plate 84 via a power source 108. The first bipolar plate 84 is electrically coupled to the first electrode 90. The first electrode 90 can include a conductive material, e.g., a nickel mesh. The first electrode 90 is a mesh material, thereby allowing for electrolysis reaction products, e.g., gaseous bubbles such as O₂, to form.

Adjacent to the first electrode 90 is a diaphragm 92. The diaphragm 92 can be non-conductive to electrons. The diaphragm 92 can include a composite material, e.g., Zirconia and polysulfone. Without being bound by theory, the diaphragm 92 can allow OH⁻ ions to pass through the diaphragm 92, while restricting H₂ and O₂ gases from passing through.

Adjacent to the diaphragm 92 is a second electrode 94 and a second channel 96. The second channel 96 may be a channel suitable to recover one or more reaction products of an electrolysis reaction, e.g., H₂. For example, the second channel 96 may be suitable to recover a reaction product of H₂. The second electrode 94 can include a conductive material, e.g., a nickel mesh. The second electrode 94 is a mesh material, thereby allowing for electrolysis reaction products, e.g., gaseous bubbles such as H₂, to form. Adjacent to the second electrode 94 is a second bipolar plate 100. A negative charge may be supplied to the second bipolar plate 100 via the power source 108. The second bipolar plate 100 is electrically coupled to the second electrode 94.

The electrolyzer cell 44 is immersed in an electrolyte solution 104. The electrolyte solution 104 includes an alkaline solution, e.g., a solution having a pH greater than 7, e.g., greater than 7.5, greater than 8, greater than 9, greater than 10, or greater than 11. The alkaline solution can include an aqueous solution having an electrolyte, e.g., a hydroxide electrolyte. For example, the electrolyte solution can include a mixture of water and potassium hydroxide. The electrolyzer cell 44 receives water and/or electrolyte solution 104 from a pump 106. The pump 106 can include any pump suitable to circulate an aqueous fluid, e.g., water and/or the electrolyte solution 104.

In operation, the electrolyzer cell 44 may receive a positive charge at the first bipolar plate 84 and a negative charge at the second bipolar plate 100, thereby creating a voltage difference across the first electrode 90 and the second electrode 94, which is separated by the diaphragm 92. Due to the voltage difference and the supply of aqueous water from the pump 106, water maybe reduced on the second electrode 94 to form H₂. The H₂ may then diffuse and be directed out of the second channel 96, e.g., via convectional flow. The OH⁻ may transfer through the diaphragm and be oxidized on the first electrode 90 to produce H₂O and O₂. The O₂ may diffuse and be directed out the first channel 88, e.g., via convectional flow, in which the H₂O may recirculate throughout the electrolyzer cell 44 to be further reacted.

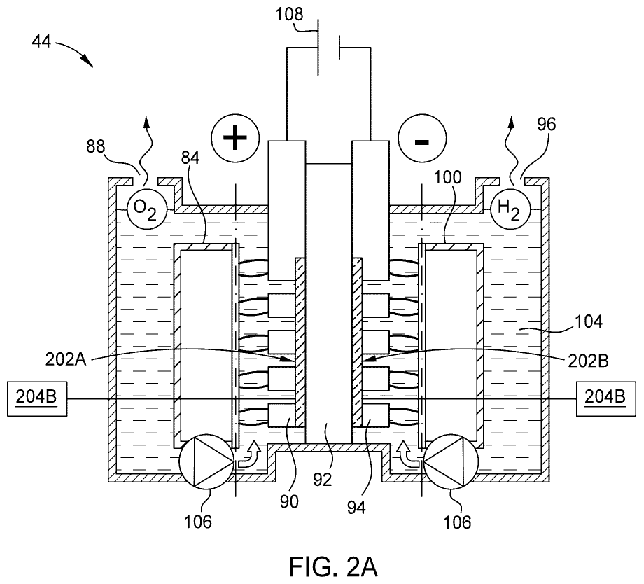

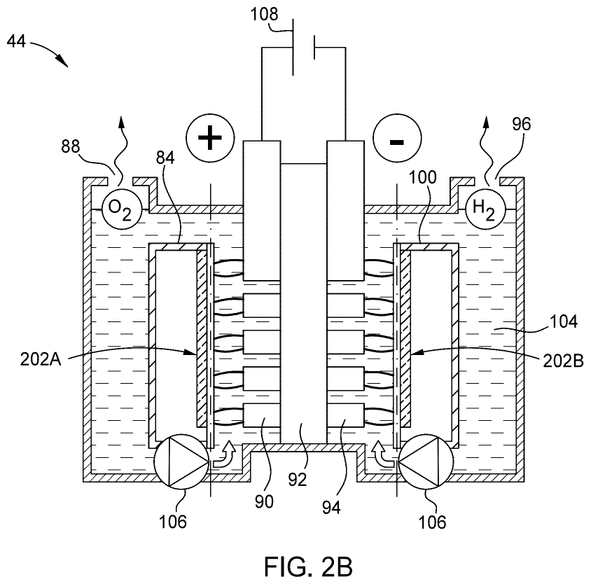

FIG. 2A shows a detailed view of the electrolyzer cell 44 having an actuator. A first actuator 202A is embedded in the first electrode set, e.g., in the first electrode 90 and/or the first bipolar plate 84. The first actuator 202A includes a piezo actuator. The piezo actuator can include a disc piezo actuator, a compact piezo actuator, a piezo stack, a tube piezo actuator, and/or a combination thereof. The piezo actuator can include a thickness of about 0.1 mm to about 10 mm, e.g., about 0.1 mm to about 9 mm, about 0.2 mm to about 5 mm, about 0.5 mm to about 3 mm, or about 0.9 mm to about 1.1 mm. The piezo actuator can include a diameter of about 0.1 mm to about 10 cm, e.g., about 0.1 mm to about 10 cm, about 1 mm to about 1 cm, or about 1 mm to about 5 mm.

The first actuator 202A can oscillate at a frequency of about 1 Hz to about 250,000 Hz. A second power supply 204A can be electrically coupled to the first actuator 202A. The second power supply 204A can provide a current of about 1 μA to about 10 A to the first actuator 202A. Additionally, the second power supply 204A can provide a power of about 1 μW to about 10 μW to the first actuator 202A.

The first actuator 202A can be disposed proximal to a diaphragm 92, described herein. Without being bound by theory, the first actuator 202A can cause an oscillation force such that a vibration of the diaphragm 92 occurs, which can further reduce gaseous bubbles from adhering to one or more surfaces. Additionally, and without being bound by theory, the vibration can reduce and/or eliminate hydrogen permeation through the diaphragm 92, increasing safety and improving gas purity. Moreover, and without being bound by theory, the oscillation force can induce turbulence within the flow of the electrolytes in the electrolyte solution, thereby causing perturbation of the electrolytes close to the first electrode surface, which can enhance mass transfer rates of gaseous bubbles from a first electrode surface. In addition, the perturbation of the electrolytes close to the first electrode surface, which can enhance mass transfer rates of reactant and product for the first electrode reactions, therefore, can improve the their diffusivities. While the first actuator 202A is embedded in the first electrode 90, proximal to the diaphragm 92, the first actuator 202A can be embedded in the first electrode 90, proximal to the first bipolar plate 84. Without being bound by theory, a first actuator 202A embedded in the first electrode 90, proximal to the first bipolar plate 84, can provide the same functionally of expelling gas bubble adhesion on the electrode and/or diaphragm surface.

A second actuator 202B can be embedded in the second electrode set, e.g., in the second electrode 94 and/or the second bipolar plate 100. The second actuator 202B includes a piezo actuator. The piezo actuator can include a disc piezo actuator, a compact piezo actuator, a piezo stack, a tube piezo actuator, and/or a combination thereof. The piezo actuator can include a thickness of about 0.1 mm to about 10 mm, e.g., about 0.1 mm to about 9 mm, about 0.2 mm to about 5 mm, about 0.5 mm to about 3 mm, or about 0.9 mm to about 1.1 mm. The piezo actuator can include a diameter of about 0.1 mm to about 10 cm, e.g., about 0.1 mm to about 10 cm, about 1 mm to about 1 cm, or about 1 mm to about 5 mm.

The second actuator 202B can oscillate at a frequency of about 1 Hz to about 250,000 Hz. A third power supply 204B can be electrically coupled to the second actuator 202B. The third power supply 204B can provide a current of about 1 μA to about 10 A to the second actuator 202B. Additionally, the second power supply 204A can provide a power of about 1 μW to about 10 W to the second actuator 202B.

The second actuator 202B can be disposed proximal to a diaphragm 92, described herein. Without being bound by theory, the second actuator 202B can cause an oscillation force such that a vibration of the diaphragm 92 occurs, which can further reduce gaseous bubbles from adhering to one or more surfaces, Additionally, and without being bound by theory, the vibration can reduce and/or eliminate hydrogen permeation through the diaphragm 92, increasing safety and improving gas purity. Moreover, and without being bound by theory, the oscillation force can induce turbulence within the flow of the electrolytes in the electrolyte solution, thereby causing perturbation of the electrolytes close to the second electrode surface, which can enhance mass transfer rates of gaseous bubbles from a second electrode surface. In addition, the perturbation of the electrolytes close to the second electrode surface, which can enhance mass transfer rates of reactant and product for the second electrode reaction, therefore, can improve the their diffusivities. While the second actuator 202B is embedded in the second electrode 94, proximal to the diaphragm 92, the second actuator 202B can be embedded in the second electrode 94, proximal to a second bipolar plate 100, as described herein. Without being bound by theory, a second actuator 202B embedded in the second electrode 94, proximal to the second bipolar plate 100, can provide the same functionally of expelling gas bubble adhesion on the electrode and/or diaphragm surface.

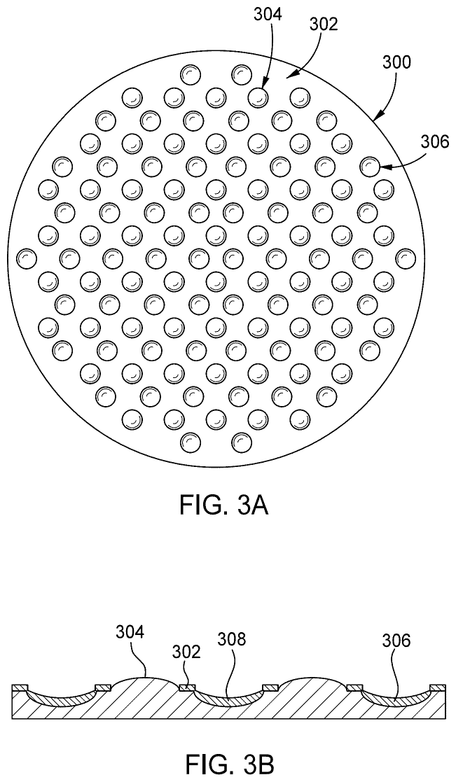

Optionally, each of the first actuator 202A and the second actuator 202B can be embedded in the first bipolar plate 84 and/or the second bipolar plate 100, as shown in FIG. 2B. The first actuator 202A and/or the second actuator 202B can be independently disposed proximal to the first electrode 90 and/or the second electrode 94, respectively. Without being bound by theory, the first actuator 202A and/or the second actuator 202B independently disposed proximal to the first electrode 90 and/or the second electrode 94, respectively, can cause produce an oscillation force, which can further reduce gaseous bubbles from adhering to one or more surfaces, and promote diaphragm ionic conductivity. Moreover, and without being bound by theory, the first actuator 202A and/or the second actuator 202B independently disposed proximal to the first electrode 90 and/or the second electrode 94, respectively, can provide the same functionally of expelling gas bubble adhesion on the electrode and/or diaphragm surface. While the first actuator 202A and/or the second actuator 202B proximal to the first electrode 90 and/or the second electrode 94, respectively, as shown in FIG. 3B, the first actuator 202A and/or the second actuator 202B can be independently disposed distal to the first electrode 90 and/or the second electrode 94. Without being bound by theory, the first actuator 202A and/or the second actuator 202B independently disposed distal to the first electrode 90 and/or the second electrode 94, respectively, can provide reduced manufacturing costs.

Optionally, one actuator may be disposed in a plurality of electrolyzer cells 44. For example, a first electrode cell having a first bipolar plate, a first electrode, a first diaphragm, a second electrode, and a second bipolar plate may include a first actuator, in which a second electrode cell having a third bipolar plate, a third electrode, a second diaphragm, a fourth electrode, and a fourth bipolar plate may not have an actuator. The first actuator may be disposed proximal to the first channel or the second channel. Without being bound by theory, the first actuator may provide sufficient oscillation to vibrate the first electrode cell and the second electrode cell.

Optionally, the first electrode cell and the second electrode cell each independently include an actuator. For example, the first electrode cell includes a first actuator and the second electrode cell includes a second actuator. The first actuator may be disposed proximal to the first channel or the second channel, and the second actuator may be disposed proximal to the third channel or the fourth channel. Without being bound by theory, by having a first actuator disposed proximal to the first channel or the second channel, and the second actuator disposed proximal to the third channel or the fourth channel, an increase in movement of the gaseous bubbles may occur, thereby improving current density in the electrode area adjacent to the first channel, second channel, third channel, and/or fourth channel, where larger amount of gas bubbles are expected to accumulate around.

Optionally, a plurality of actuators may be disposed in an electrolyzer cell 44. For example, a first electrode cell having a first bipolar plate, a first electrode, a first diaphragm, a second electrode, and a second bipolar plate may include a plurality of actuators, e.g., a first actuator and a third actuator embedded within the first bipolar plate 84, the first electrode 90, the second electrode 94, or the second bipolar plate 100. For example, the electrolyzer cell 44 can include a first actuator and a third actuator embedded within the first electrode 90. The first actuator may be disposed proximal to the first channel and the third actuator may be disposed distal to the first channel.

The first bipolar plate 84, optionally having the first actuator 202A embedded therein, can abut the first electrode 90, optionally having the first actuator 202A embedded therein, which can abut the diaphragm 92, and the second bipolar plate 100, optionally having the second actuator 202B embedded therein, can abut the second electrode 94, optionally having the second actuator 202B embedded therein, which can abut the diaphragm, in which at least one actuator is present, thereby reducing one or more gaps formed between the first bipolar plate 84, the first electrode 90, the diaphragm 92, the second electrode 94, and/or the second bipolar plate. Without being bound by theory, by reducing one or more gaps formed in the electrolyzer cell 44, the oscillation force can be focused in the electrolyzer cell, thereby improving the oscillation force exerted on the gaseous bubbles, and increasing gas expulsion and efficiency of the electrolysis process. Moreover, and without being bound by theory, improving the oscillation force exerted on the gaseous bubbles can reduce and/or eliminate hydrogen permeation through the diaphragm, thereby increasing safety and improving gas purity.

FIG. 3A shows a detailed view of a bipolar plate 300. The bipolar plate 300 can include any of the first bipolar plate 84 and/or the second bipolar plate 100, as described herein. The bipolar plate 300 can include a planar portion 302. The planar portion 302 includes a portion that is substantially planar and/or flat. A convex portion 304 extends from the planar portion 302. The convex portion 304 can extend from the planar portion 302 in a substantially circular, spherical, or cylindrical manner. The convex portion 304 can extend from the planar portion 302 such that the convex portion 304 contacts the electrode, e.g., the first electrode 90 and/or the second electrode 94, as described herein. While FIG. 3A shows one arrangement of convex portions on the bipolar plate 300, any number of arrangements of convex portions may be implemented on the bipolar plate 300.

A concave portion 306 is recessed within the planar portion 302. The concave portion 306 can recess from the planar portion 302 in a substantially circular, spherical, or cylindrical manner. The concave portion 306 can recess from the planar portion 302 such that the gas bubbles and/or fluid may interact with the concave portion 306. While FIG. 3A shows one arrangement of convex portions on the bipolar plate 300, any number of arrangements of convex portions may be implemented on the bipolar plate 3200.

A coating material 308 is disposed on at least a portion of the bipolar plate 300. For example, the coating material 308 can be disposed on the planar portion 302 and/or the concave portion 306, as shown in FIG. 3B. The coating material 308 is not disposed on the portion of the bipolar plate 300 that contacts the electrode, e.g., the convex portion 304. The coating material 308 is an aerophobic material, in which an “aerophobic material,” as used herein represents a material that includes poor adhesion to gaseous compounds, e.g., oxygen and/or hydrogen. An aerophobic material may include a thickness of about 1 nm to about 100 μm. The aerophobic material can include a fluoropolymer material, e.g., polytetrafluoroethylene, or a silicone polymer, e.g., polydimethylsiloxane. Without being bound by theory, by applying polytetrafluoroethylene and/or polydimethylsiloxane to a portion of the bipolar plate that is not in contact with the electrode, e.g., the planar portion 302 and/or the concave portion 306, a reduction in adhesion between a gaseous bubble such as hydrogen and/or oxygen occurs, thereby directing the gaseous bubbles to the first or second channels, reducing overpotential and increasing overall energy efficiency of the electrolyzer cell 44.

Optionally, where a first electrolyzer cell and a second electrolyzer cell are implemented, the first bipolar plate can include a first coating material disposed over a first portion of the first bipolar plate that does not contact the first electrode, the second bipolar plate can include a second coating material disposed over a second portion of the second bipolar plate that does not contact the second electrode, the third bipolar plate can include a third coating material disposed over a third portion of the third bipolar plate that does not contact the third electrode, the fourth bipolar plate can include a fourth coating material disposed over a fourth portion of the fourth bipolar plate that does not contact the fourth electrode. The first coating material, the second coating material, the third coating material, and the fourth coating material may independently be a fluoropolymer material, e.g., polytetrafluoroethylene, or a silicone polymer, e.g., polydimethylsiloxane.

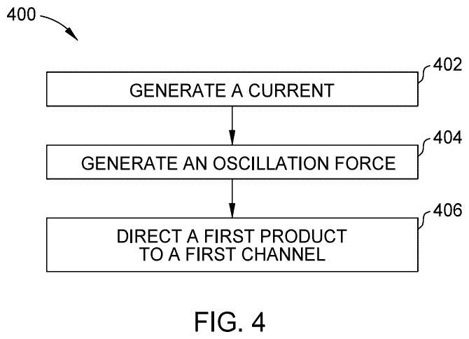

FIG. 4 shows a flow diagram of a method 400 for electrolyzing water. The method includes, at step 402, generating a current between a first electrode set and a second electrode set that are separated by a diaphragm 92. Water is circulated within one of the first electrode set or the second electrode set. The first electrode set includes a first bipolar plate 84 electrically coupled to a power source 108. A first electrode 90 is disposed adjacent to the first bipolar plate 84 and to a first side of the diaphragm 92, and in electrical contact with the first bipolar plate 84. The second electrode set includes a second bipolar plate 100 and a second electrode 94. The second electrode is disposed adjacent to a second side of the diaphragm. The second side of the diaphragm is opposite the first side of the diaphragm. The second electrode 94 is in electrical contact with the second bipolar plate 100. The current, in the presence of water, produces an electrolysis reaction converting H₂O to H₂ and O₂.

A power source 108 provides a positive charge to the first bipolar plate 84, and a negative charge to the second bipolar plate 100, thereby creating a voltage difference across the first electrode 90 and the second electrode 94, which are each electrically coupled to the first bipolar plate 84 and the second bipolar plate 100, respectively. The charge difference creates the current, e.g., an electric field, that is directed towards the first bipolar plate 84.

At operation 404, a first oscillation force is generated such that the oscillation force perturbs the electrolyte solution 104. The oscillation force is generated using a first actuator 202A disposed within the first electrode set. The first actuator 202A can be embedded within the first bipolar plate 84, the first electrode 90, the second electrode 94, and/or the second bipolar plate 100. The oscillation force can cause a turbulence in the first electrode set, thereby disrupting the water, ions and/or radicals species within the electrolyte solution 104. Without being bound by theory, the turbulence can remove the gas bubble adhesion on the first electrode 90, thereby opening more electrode area for electrolysis reactions to occur.

A second power supply 204A provides a current to the first actuator 202A. The current can be about 1 μA to about 10 A. The second power supply 204A can provide a power of about 1 μW to about 10 W to the first actuator 202A. The first actuator 202A can oscillate at a frequency of about 1 Hz to about 250,000 Hz when powered by the second power supply 204A. The oscillation force is produced by the first actuator 202A oscillating at the frequency of about 1 Hz to about 250,000 Hz.

At operation 406, a first product of an electrolysis reaction, e.g., O₂, is directed to the first channel 86 fluidly coupled to the first electrode 90 using the diaphragm 92 and the first oscillation force. For example, the OH⁻ may pass through the diaphragm 92. The OH⁻ may be oxidized at the first electrode 90 to form O₂ and be detached from the first electrode by the first oscillation force to the first channel 88.

Optionally, a second product of an electrolysis reaction, e.g., H₂, is directed to the second channel 96 fluidly coupled to the second electrode 94 using the diaphragm 92 and the first oscillation force. For example, H₂O may be reduced at the second electrode 94 to form H₂ and be detached from the second electrode by the first oscillation force to the second channel 96.

Optionally, a second oscillation force may be generated in a second electrode set. The second electrode set can include a second actuator 202B is electrically coupled to a third power supply 204B. The third power supply 204B can provide a current to the second actuator 202B. The current can be about 1 μA to about 10 A. The third power supply 204B can provide a power of about 1 μW to about 10 W to the second actuator 202B. The second actuator 202B can oscillate at a frequency of about 1 Hz to about 250,000 Hz when powered by the third power supply 204B. The oscillation force is produced by the second actuator 202B oscillating at the frequency of about 1 Hz to about 250,000 Hz.

The second product of an electrolysis reaction, e.g., H₂, can be directed to the second channel 96 fluidly coupled to the second electrode 94 using the diaphragm 92 and the second oscillation force. The H₂O may be reduced at the second electrode 94 to form H₂ and be detached from the second electrode by the second oscillation force to the second channel 96.

Overall, the present disclosure includes a coating material disposed on a bipolar plate, e.g., a concave or planar portion of the bipolar plate, to prevent bubble adhesion to the bipolar plate walls. The coating material facilitates movement of the bubbles, e.g., gas bubbles of hydrogen and/or oxygen, towards the manifold to help improve overall energy efficiency and reduce over-potential. Additionally, the present disclosure includes an actuator embedded within the electrode and/or bipolar plate to generate a provide an ultrasonic and/or vibrational frequency in the electrolysis stack. The ultrasonic and/or vibrational frequency can forcefully move bubbles e.g., gas bubbles of hydrogen and/or oxygen, towards the manifold to help improve overall energy efficiency and reduce over-potential. The present disclosure can provide a large-scale water electrolysis process capable of providing intimate direct vibrational frequencies, thereby avoiding large-scale external ultrasonic frequencies that may be with health hazards, less effective and/or possibly more costly.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

Numerical ranges used herein include the numbers recited in the range. For example, the numerical range “from 1 wt % to 10 wt %” includes 1 wt % and 10 wt % within the recited range.

For the sake of brevity, only some ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

### EMBODIMENTS

Implementation examples are described in the following numbered clauses:

E1. A system for electrolyzing water, the system comprising a first electrode set comprising a first bipolar plate electrically coupled to a first power source, a first electrode disposed adjacent to the first bipolar plate and in electrical contact with the first bipolar plate; and a first actuator embedded in the first electrode set, wherein the first actuator is electrically coupled to a second power source, a diaphragm, wherein the first electrode is disposed adjacent to a first side of the diaphragm; and a second electrode set comprising a second bipolar plate and a second electrode, wherein the second electrode is disposed adjacent to a second side of the diaphragm, the second side opposite the first side.

E2. The system of embodiment E1, wherein the first actuator is proximal to the first bipolar plate.

E3. The system of embodiments E1 or E2, wherein the first actuator is proximal to the diaphragm.

E4. The system of any one of embodiments E1-E3, wherein the first actuator is proximal to a first channel fluidly coupled to the first electrode set.

E5. The system of any one of embodiments E1-E4, wherein the second electrode set further comprises a second actuator embedded in the second electrode set.

E6. The system of embodiment E5, wherein the second actuator is proximal to the second bipolar plate or the diaphragm.

E7. The system of embodiment E5, wherein the second actuator is proximal to a second channel fluidly coupled to the second electrode set.

E8. The system of any one of embodiments E1-E7, wherein the first actuator comprises a piezo actuator.

E9. The system of embodiment E8, wherein the piezo actuator oscillates at a frequency of about 1 Hz to about 250,000 Hz.

E10. The system of any one of embodiments E1-E9, wherein the first bipolar plate comprises a first coating material disposed over a first portion of the first bipolar plate.

E11. The system of embodiment E10, wherein the second bipolar plate comprises a second coating material disposed over a second portion of the second bipolar plate.

E12. The system of embodiment E11, wherein the first coating material and the second coating material independently comprises an aerophobic material.

E13. The system of embodiment E12, wherein the aerophobic material comprises a fluoropolymer or a silicone polymer.

E14. The system of embodiment E13, wherein the first bipolar plate comprises a first uncoated portion in contact with the first electrode, and the second bipolar plate comprises a second uncoated portion in contact with the second electrode.

E15. The system of any one of embodiments E1-E14, the system comprising a first electrode stack comprising a first cell having the first electrode set, the diaphragm and the second electrode set, at least a second cell comprising a third electrode set, wherein the third electrode set comprises a third bipolar plate and a third electrode, a second diaphragm, wherein the second electrode set is disposed adjacent to a first side of the second diaphragm; and a fourth electrode set, wherein the fourth electrode set comprises a fourth bipolar plate and a fourth electrode, wherein the fourth electrode is disposed adjacent to a second side of the second diaphragm, the second side of the second diaphragm opposite the first side of the second diaphragm.

E16. The system of embodiment E15, wherein the first bipolar plate comprises a first coating material disposed over a portion of the first bipolar plate; the second bipolar plate comprises a second coating material disposed over a portion of the second bipolar plate; the third bipolar plate comprises a third coating material disposed over a portion of the third bipolar plate; and the fourth bipolar plate comprises a fourth coating material disposed over a portion of the fourth bipolar plate.

E17. The system of embodiment E16, wherein the first coating material, the second coating material, the third coating material, and the fourth coating material independently comprises an aerophobic material, wherein the aerophobic material comprises a fluoropolymer or a silicone polymer.

E18. The system of any one of claims 1-17, further comprising a third actuator embedded in the first electrode.

E19. A method for electrolyzing water, the method comprising generating a current between a first electrode set and a second electrode set separated by a diaphragm, and circulating water within one of the first electrode set or the second electrode set, wherein the first electrode set comprises a first bipolar plate electrically coupled to a power source, and a first electrode disposed adjacent to the first bipolar plate and to a first side of the diaphragm and in electrical contact with the first bipolar plate, wherein the second electrode set comprises a second bipolar plate and a second electrode, the second electrode is disposed adjacent to a second side of the diaphragm, the second side opposite the first side, and in electrical contact with the second bipolar plate, and wherein the current, in the presence of water, produces an electrolysis reaction generating a first oscillation force in the first electrode set using a first actuator directing a first product of the electrolysis reaction to a first channel fluidly coupled to the first electrode set using the diaphragm and the first oscillation force diaphragm.

E20. The method of embodiment E19, further comprising directing a second product of the electrolysis reaction to a second channel fluidly coupled to the second electrode set using the diaphragm and the first oscillation force.

E21. The method of embodiments E19 or E20, wherein generating the first oscillation force in the first electrode set further comprises providing a current to the first actuator; and oscillating the first actuator, using the current, at a frequency of about 1 Hz to about 250,000 Hz.

E22. The method of embodiment E21, wherein the first actuator comprises a piezo actuator.

E23. The method of any one of embodiments E19-22, further comprising generating a second oscillation force in the second electrode set, wherein the second electrode set further comprises a second actuator; and directing the second product of the electrolysis reaction to the second channel fluidly coupled to the second electrode set using the diaphragm and the second oscillation force.

E24. The method of embodiment E23, wherein generating the second oscillation force in the second electrode set further comprises providing a current to the second actuator; and oscillating the second actuator, using the current, at a frequency of about 1 Hz to about 250,000 Hz.

E25. The method of any one of embodiments E19-24, wherein generating the first oscillation force further comprises generating a turbulence in the first electrode set.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A system for electrolyzing water, the system comprising:
a first electrode set comprising:
a first bipolar plate electrically coupled to a first power source;
a first electrode disposed adjacent to the first bipolar plate and in electrical contact with the first bipolar plate; and
a first actuator embedded in the first electrode set, wherein the first actuator is electrically coupled to a second power source;
a diaphragm, wherein the first electrode is disposed adjacent to a first side of the diaphragm; and
a second electrode set comprising:
a second bipolar plate and a second electrode, wherein the second electrode is disposed adjacent to a second side of the diaphragm, the second side opposite the first side.

2. The system of claim 1, wherein the first actuator is proximal to the first bipolar plate.

3. The system of claim 1, wherein the first actuator is proximal to the diaphragm.

4. The system of claim 1, wherein the first actuator is proximal to a first channel fluidly coupled to the first electrode set.

5. The system of claim 1, wherein the second electrode set further comprises a second actuator embedded in the second electrode set.

6. The system of claim 5, wherein the second actuator is proximal to the second bipolar plate or the diaphragm.

7. The system of claim 5, wherein the second actuator is proximal to a second channel fluidly coupled to the second electrode set.

8. The system of claim 1, wherein the first actuator comprises a piezo actuator that oscillates at a frequency of about 1 Hz to about 250,000 Hz.

9. The system of claim 1, wherein the first bipolar plate comprises a first coating material disposed over a first portion of the first bipolar plate.

10. The system of claim 9, wherein the second bipolar plate comprises a second coating material disposed over a second portion of the second bipolar plate, wherein the first coating material and the second coating material independently comprises an aerophobic material, and the aerophobic material comprises a fluropolymer or a silicone polymer.

11. The system of claim 10, wherein the first bipolar plate comprises a first uncoated portion in contact with the first electrode, and the second bipolar plate comprises a second uncoated portion in contact with the second electrode.

12. The system of claim 1, the system comprising a first electrode stack comprising:
a first cell having the first electrode set, the diaphragm and the second electrode set,
at least a second cell comprising:
a third electrode set, wherein the third electrode set comprises a third bipolar plate and a third electrode,
a second diaphragm, wherein the second electrode set is disposed adjacent to a first side of the second diaphragm; and
a fourth electrode set, wherein the fourth electrode set comprises a fourth bipolar plate and a fourth electrode, wherein the fourth electrode is disposed adjacent to a second side of the second diaphragm, the second side of the second diaphragm opposite the first side of the second diaphragm.

13. The system of claim 12, wherein:
the first bipolar plate comprises a first coating material disposed over a portion of the first bipolar plate;
the second bipolar plate comprises a second coating material disposed over a portion of the second bipolar plate;
the third bipolar plate comprises a third coating material disposed over a portion of the third bipolar plate; and
the fourth bipolar plate comprises a fourth coating material disposed over a portion of the fourth bipolar plate.

14. The system of claim 13, wherein the first coating material, the second coating material, the third coating material, and the fourth coating material independently comprises an aerophobic material, wherein the aerophobic material comprises a fluoropolymer or a silicone polymer.

15. The system of claim 1, further comprising a third actuator embedded in the first electrode.

16. A method for electrolyzing water, the method comprising:
generating a current between a first electrode set and a second electrode set separated by a diaphragm, and circulating water within one of the first electrode set or the second electrode set,
wherein the first electrode set comprises a first bipolar plate electrically coupled to a power source, and a first electrode disposed adjacent to the first bipolar plate and to a first side of the diaphragm and in electrical contact with the first bipolar plate,
wherein the second electrode set comprises a second bipolar plate and a second electrode, the second electrode is disposed adjacent to a second side of the diaphragm, the second side opposite the first side, and in electrical contact with the second bipolar plate, and
wherein the current, in the presence of water, produces an electrolysis reaction generating a first oscillation force in the first electrode set using a first actuator; and
directing a first product of the electrolysis reaction to a first channel fluidly coupled to the first electrode set using the diaphragm and the first oscillation force.

17. The method of claim 16, further comprising directing a second product of the electrolysis reaction to a second channel fluidly coupled to the second electrode set using the diaphragm and the first oscillation force.

18. The method of claim 16, wherein generating the first oscillation force in the first electrode set further comprises:
providing a current to the first actuator, wherein the first actuator comprises a piezo actuator; and
oscillating the first actuator, using the current, at a frequency of about 1 Hz to about 250,000 Hz.

19. The method of claim 16, further comprising:
generating a second oscillation force in the second electrode set, wherein the second electrode set further comprises a second actuator, wherein generating the second oscillation force in the second electrode set further comprises:
providing a current to the second actuator; and
oscillating the second actuator, using the current, at a frequency of about 1 Hz to about 250,000 Hz; and
directing the second product of the electrolysis reaction to the second channel fluidly coupled to the second electrode set using the diaphragm and the second oscillation force.

20. The method of claim 16, wherein generating the first oscillation force further comprises generating a turbulence in the first electrode set.
